(19) United States
(12) Patent Application Publication
(10) Pub. No.: US 2026/0278745 A1
(43) Pub. Date: Sep. 17, 2026

(54) IMAGE ENHANCEMENT ACCELERATION BY PATCH-WISE REGRESSION

(71) Applicant: DOLBY LABORATORIES LICENSING CORPORATION

(72) Inventors: Tsung-Wei HUANG, Fremont, CA (US); Guan-Ming SU, Fremont, CA (US)

(73) Assignee: DOLBY LABORATORIES LICENSING CORPORATION, (US)

(21) Appl. No.: 19/471,514

(22) PCT Filed: Mar. 28, 2024
(86) PCT No.: PCT/US2024/021823

§ 371 Date: Oct. 1, 2025

Related U.S. Application Data
(60) Provisional application No. 63/494,313, filed on Apr. 5, 2023.

(51) Int. Cl. G06T 5/60; G06T 3/40

(52) U.S. Cl. CPC G06T 5/60; G06T 3/40; G06T 2207/20021

(57) ABSTRACT

A still or video image is enhanced through a patch-wise regression model. The model can be used to accelerate the image enhancement by downsampling the image before enhancement then applying patch-wise regression, using patch-wise regression to provide metadata for predicting an enhanced image from an unenhanced source image, or both in combination. The model can accelerate, for example, contrast, brightness, and/or saturation enhancement techniques, including techniques that only enhance a portion of the image.

### CROSS-REFERENCE TO RELATED APPLICATIONS

This application claims priority of U.S. Provisional Application No. 63/494,313 filed Apr. 5, 2023, which is hereby incorporated by reference.

### TECHNOLOGY

The present disclosure relates generally to image processing operations. More particularly, an embodiment of the present disclosure relates to accelerated image enhancement.

### BACKGROUND

Image enhancement techniques, such as brightness correction, contrast and saturation enhancement, are widely used to improve the viewing experience of low-quality images or make ordinary images looks more vivid. However, most of them are computationally expensive and not suitable for real-time applications such as video conferencing or live event broadcasting. Besides, when performing the enhancement on the server between uploader and client, re-encoding the enhanced images introduce additional overhead.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### SUMMARY

An embodiment of the present invention is a method for image enhancement of a source image, the method comprising: downsampling the source image to produce a downsampled image; enhancing the downsampled image to produce an enhanced downsampled image; dividing the enhanced downsampled image into blocks; determining patches over each of the blocks such that each patch overlaps at least one surrounding block; and creating a predicted enhanced image using a patch-wise regression model based on said patches on the source image.

In some embodiments, the method is performed at an image uploader and the predicted enhanced image is sent to a server or a client system. In some embodiments, the method is performed at an image server and the source image is obtained from an image uploader system and the predicted enhanced image is sent to a client system. In some embodiments, the method is performed at a client system and the source image is obtained from an image uploader system or an image server system and the predicted enhanced image is stored by the client system and/or displayed by the client system.

An embodiment of the present invention is a method for image enhancement of a source image, the method comprising: enhancing the source image; using a patch-wise regression model to determine coefficients configured to predict an enhanced image; sending the coefficients as metadata to a client for predicting an enhanced image.

An embodiment of the present invention is a method of image enhancement of a source image, the method comprising: receiving the source image and metadata related to the source image; extracting patch-wise regression coefficients from the metadata; spatially upsampling the patch-wise regression coefficients to produce spatially upsampled coefficients; creating a predicted enhanced image by using a patch-wise regression model with the spatially upsampled coefficients on the source image.

A method may be computer-implemented in some embodiments. For example, the method may be implemented, at least in part, via a control system comprising one or more processors and one or more non-transitory storage media.

Some or all of the methods described herein may be performed by one or more devices according to instructions (e.g. software) stored on one or more non-transitory media. Such non-transitory media may include memory devices such as those described herein, including but not limited to random access memory (RAM) devices, read-only memory (ROM) devices, etc.

Accordingly, various innovative aspects of the subject matter described in this disclosure may be implemented in a non-transitory medium having software stored thereon. The software may, for example, be executable by one or more components of a control system such as those disclosed herein. The software may, for example, include instructions for performing one or more of the methods disclosed herein.

At least some aspects of the present disclosure may be implemented via an apparatus or apparatuses. For example, one or more devices may be configured for performing, at least in part, the methods disclosed herein. In some implementations, an apparatus may include an interface system and a control system. The interface system may include one or more network interfaces, one or more interfaces between the control system and memory system, one or more interfaces between the control system and another device and/or one or more external device interfaces. The control system may include at least one of a general-purpose single- or multi-chip processor, a digital signal processor (DSP), an application specific integrated circuit (ASIC), a field programmable gate array (FPGA) or other programmable logic device, discrete gate or transistor logic, or discrete hardware components. Accordingly, in some implementations the control system may include one or more processors and one or more non-transitory storage media operatively coupled to one or more processors.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings generally indicate like elements, but different reference numbers do not necessarily designate different elements between different drawings.

### BRIEF DESCRIPTION OF THE DRAWINGS

An embodiment of the present invention is illustrated by way of example, and not by way of limitation, in the figures of the accompanying drawings and in which like reference numerals refer to similar elements and in which:

FIG. 1 illustrates an example flowchart of image enhancement acceleration by patch-wise regression of a downsampled image.

FIG. 2 illustrates an example flowchart of image enhancement acceleration by creating patch-wise regression coefficients to be sent as metadata with the image.

FIG. 3 illustrates an example flowchart of image enhancement acceleration by creating patch-wise regression coefficients based on a downsampled image to be sent as metadata with the original image.

FIG. 4 illustrates how a patch can be defined for patch-wise regression models.

FIG. 5 shows an example graph of fitting the regression model within the patch.

FIG. 6 illustrates an example flowchart of minimizing a cost function to determine coefficients for a patch-wise regression model.

FIG. 7 illustrates an example flowchart of utilizing the model coefficients to predict an enhanced image.

FIGS. 8A and 8B show a comparison of downsampled and original patches.

FIG. 9 illustrates an example flowchart of predicting an enhanced image by downsampling the source image, then upsampling the model coefficients.

FIG. 10 shows an example graph of the trade-off between quality and processing time.

FIG. 11 shows an example graph of different quantization methods.

FIG. 12 illustrates an example flowchart of image enhancement acceleration through metadata encoding of model coefficients.

FIG. 13 illustrates an example flowchart of image enhancement acceleration through metadata encoding of model coefficients and downsampling the source image.

FIG. 14 shows an example graph of the trade-off between bitrate and quality.

FIG. 15 shows an exemplary system configuration.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are not described in exhaustive detail, in order to avoid unnecessarily occluding, obscuring, or obfuscating the present disclosure.

As used herein, “brightness” refers to the intensity of the pixels in question. “Contrast” refers to the relative difference in brightness between different groups of pixels (e.g., regions of the image). Contrast can be global (total image) or local (a neighborhood of pixels). “Saturation” refers the intensity of one or more colors of the image.

As used herein, “HSSL” refers to a hybrid shifted sigmoid function with linear mapping for contrast correction.

As used herein, “LUT” refers to a look-up table in software/firmware/hardware.

As used herein, a “block” refers to a contiguous arrangement of pixels wherein blocks in an image do not overlap. As used herein, “patch” refers to a contiguous arrangement of pixels where patches in an image can overlap.

### I. Image Enhancement

An efficient patch-wise regression model for image enhancement representation is introduced herein to address the issues in the prior art. The model has two non-exclusive applications: 1) accelerating the image enhancement process directly by down-sampling the source image then applying the model (reducing the processing cost of the enhancement process) and 2) having the model serve as metadata for predicting enhanced image from unenhanced source image (off-loading the enhancement processing to the source of the image). A contrast (e.g. HSSL) and saturation enhancement and adaptive face brightness correction (see e.g. U.S. 63/384,739 titled “Adaptive Face Brightness Adjustment for Images and Video”, incorporated by reference herein) can be used together as the enhancement process, but this framework can work with other kinds of brightness, contrast and/or saturation enhancement processes as well, including techniques that only enhance a portion of the image.

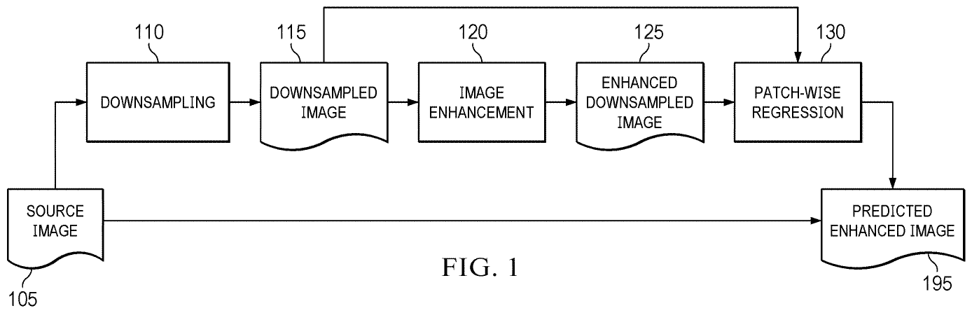

FIG. 1 shows an example flowchart for a high-level workflow of the proposed method utilizing acceleration enhancement.

This process can be done in e.g. the uploader, server, or client sides of a system. The source image (105) is first downsampled (110) to a lower resolution image (115) for a faster enhancement process. Then the image enhancement (e.g. brightness and/or contrast) model (120) fits the mapping from the downsampled source image to an enhanced downsampled image (125). Finally, the patch-wise regression model (130) predicts the enhanced image (195) in original resolution from the source image (105), the model (130) being based on the downsampled image (115) and the enhanced downsampled image (125).

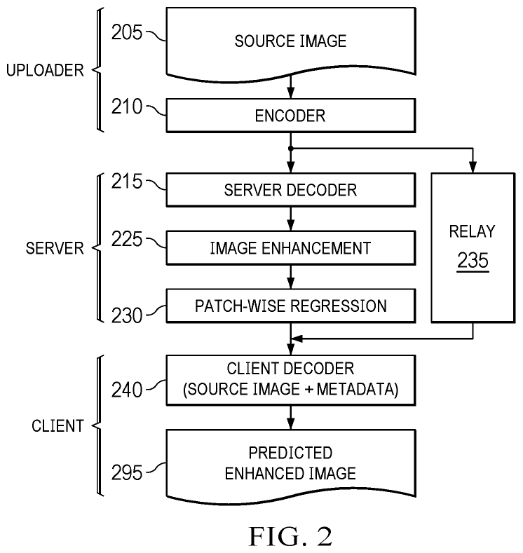

FIG. 2 shows an example flowchart for a high-level workflow of the proposed method utilizing metadata for enhancement.

The uploader encodes (210) and sends the source image (205) to the server for enhancement. On the server side, the source image is decoded (215) and sent to the enhancement process (225). Then the patch-wise regression model (230) fits a mapping from the source image to an enhanced image to be sent to the client. The patch-wise regression model (230) can be sent as metadata along with the bitstream of encoded source image provided by the relay (235). On the client side, the patch-wise regression model can be recovered from the bitstream during decoding (240), and the enhanced image can be directly predicted (295) from source image using that patch-wise regression model from the metadata.

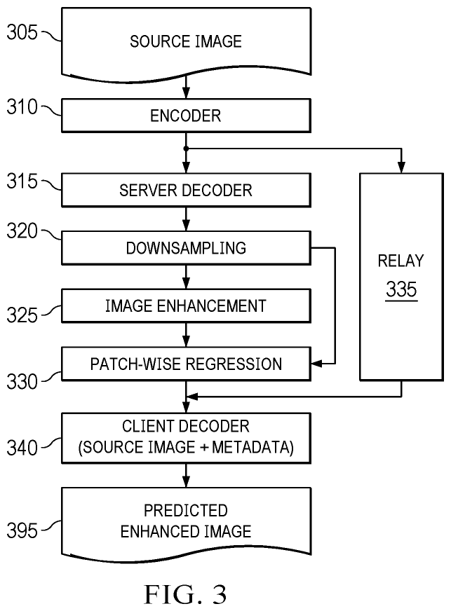

FIG. 3 shows an example flowchart for a high-level workflow of the proposed method utilizing metadata for enhancement along with acceleration.

The uploader encodes (310) and sends the source image (305) to the server for enhancement. On the server side, the source image is decoded (315) and sent to the enhancement process (325) after downsampling (320). Then the patch-wise regression model (330) fits a mapping from the downsampled image to an enhanced image to be sent to the client in downsampled resolution. The patch-wise regression model (330) can be sent as metadata along with the bitstream of encoded source image provided by the relay (335). On the client side, the patch-wise regression model can be recovered from the bitstream during decoding (340), and the enhanced image can be directly predicted (395) from source image using that patch-wise regression model from the metadata.

### II. Patch-Wise Regression Model

The patch-wise regression model that maps the source image to the enhanced image can be defined in YCbCr color space. The idea of patch-wise modeling and prediction is introduced, and then the model for each color channel is defined in detail. To simplify, assume all color channels are normalized to a [0,1] range.

### II.1 Patch-Wise Modeling

The image enhancement process can be considered in terms of brightness, contrast, and saturation. Therefore, within a small image patch, the mapping of a pixel value from the source image to a corresponding pixel in the enhanced image can be approximated as a polynomial regression model. In other words, the enhancement of an image can be represented using a patch-wise regression model, where each image patch has its own regression model representing the enhancement of the patch.

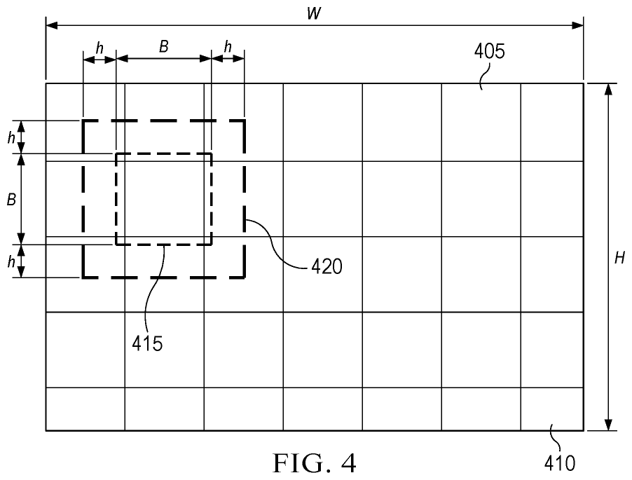

To define the patches for a source image S of resolution W×H, first partition the image into blocks of size B×B starting from the top-left corner. When W or H cannot be divided by B, the block size on the bottom and right boundaries may be smaller than B. Therefore, the numbers of rows and columns of blocks are H_{P}=┌H/B┐ and W_{P}=┌W/B┐, respectively. For spatial stability, add additional overlap h to each direction of a block to form a (B+2h)×(B+2h) patch. For example, h=B/2 can be used. In some embodiments, only consider the valid pixels when a block is on the image boundaries. Finally, if the number of coefficients of a model of a single patch is C_{P}, the patch-wise regression model P can be viewed as an H_{P}×W_{P} array and each entry is a vector of size C_{P}. FIG. 4 shows an example patch in image. The inner dashed box (415) indicates a block of size B×B, and the outer dashed box (420) is the patch after adding overlap h to each direction of the block. In an example, block size 32 can be used for the Y channel and 64 for Cb and Cr channels for a source image resolution of 1280×720. Since the box size is not an even multiple of the image size, some boxes (405) are square, and some boxes (410) are rectangular (typically at an edge of the image).

### II.1.1 Fitting of a Single Patch

For the patch of m-th row and n-th column, the goal is to find the regression model coefficient P_{(m,n)}∈ [symbol] ^{C}^{_{P}} that maps the pixel value from source image S to enhanced image V within the patch. Denoting the set of pixels within the patch as [symbol] _{(m,n)}, the source pixel values are X_{(m,n)}={s_{(i,j)}|(i,j)∈ [symbol] _{(m,n)}} and enhanced pixel values are Y_{(m,n)}={v_{(i,j)}|(i,j)∈ [symbol] _{(m,n)}}, where s_{(i,j)} and v_{(i,j)} are the pixel values of pixel (i, j) in source and enhanced image, respectively. The model coefficient can be found by minimizing the following total cost function as shown in equation 1:

$${P}_{( m , n )} = arg {min}_{p} E ( {f}_{p} ( {X}_{( m , n )} ) , {Y}_{( m , n )} ) + R ( p ) \qquad ( 1 )$$

Here fₚ is the polynomial function of coefficient p, and E is the data term which can be defined as the mean square error as shown in equation 2:

$$E ( {f}_{p} ( {X}_{( m , n )} ) , Y ) = \frac{1}{\vert {𝒩}_{( m , n )} \vert} {\sum }_{( i , j ) ∈ {𝒩}_{( m , n )}} {( {f}_{p} ( {s}_{( i , j )} ) - {v}_{( i , j )} )}^{2} \qquad ( 2 )$$

And R is the regularization term, which is defined in a later section for each color channel.

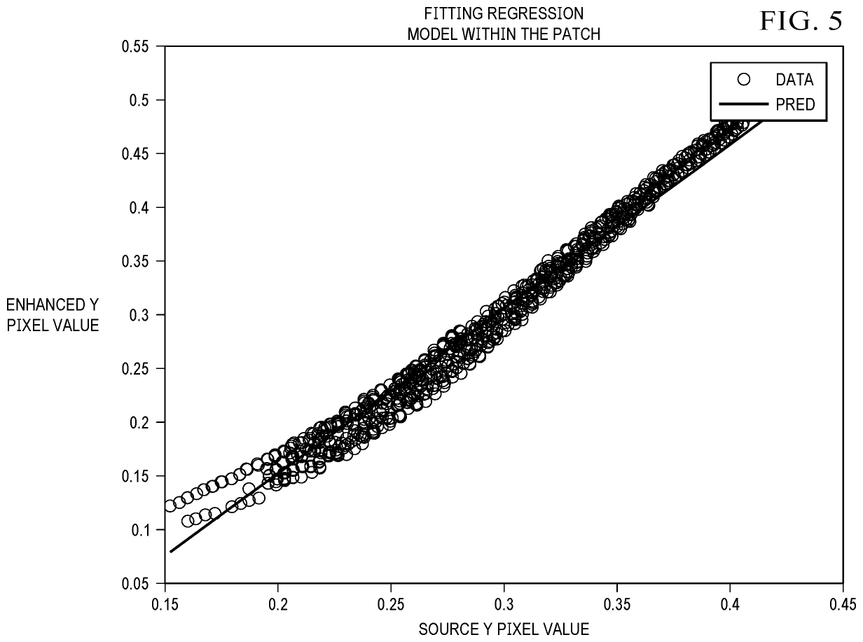

FIG. 5 shows an example of modeling between source and enhanced Y channel within a single image patch, comparing predicted values with experimental data.

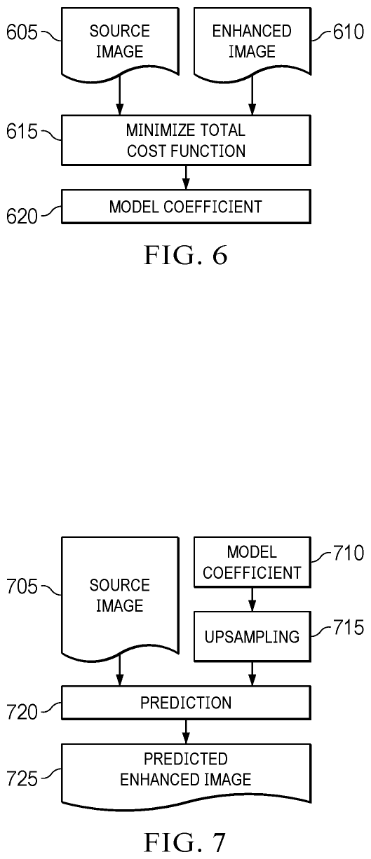

FIG. 6 shows an example fitting process of patch-wise regression model. A source image (605) and the enhanced image (610) go through a cost minimization function (615) to determine the model coefficients (620).

II.1.2 Prediction from Patch-Wise Modeling

When predicting the enhanced image using the regression model from each patch, ensure the spatial smoothness of the prediction to avoid blocky artifacts. For each pixel, apply bilinear interpolation on the coefficients of the regression models of neighboring patches before prediction. To be specific, bilinearly upsample (spatially) P from size H_{P}×W_{P} to the coefficient array \tilde{P} of size H×W. Then, perform per-pixel prediction to get the predicted enhanced image \hat{V}, where the pixel value at (i,j) is:

$${\hat{v}}_{( i , j )} = {f}_{{\tilde{P}}_{( i , j )}} ( {s}_{( i , j )} ) \qquad ( 3 )$$

FIG. 7 shows an example flowchart for a prediction process of a patch-wise regression model. A source image (705) and an upsampled (715) form of the model coefficients (710), as described above, go through a prediction (720) to determine the predicted enhanced image (725).

### II.2 Single Channel First Order Model for Luma

For computational efficiency, use a first order polynomial regression model for each color channel independently. This example below uses the Y (luma) channel, but the same operation can be applied equally to chroma (e.g. Cb and Cr) channels.

Denote the Y channel of source and enhanced images S^{Y} and V^{Y}, respectively. For pixel (i,j), the first order model is shown in equation 4:

$${f}_{p} ( {s}_{( i , j )}^{Y} ) = {p}_{1} {s}_{( i , j )}^{Y} + {p}_{2} \qquad ( 4 )$$

Regularize the slope p₁ for better stability. The regularization term can be defined as shown in equation 5:

$$R ( p ) = ϵ {p}_{1}^{2} \qquad ( 5 )$$

Where ϵ is a regularization parameter. In some embodiments, ϵ=(1/2¹⁰)² after normalizing the 10-bit source image to [0,1] scale.

Therefore, for the patch of m-th row and n-th column provides as in equation 6:

$${P}_{( m , n )}^{Y} = arg {min}_{p} \frac{1}{\vert {𝒩}_{( m , n )} \vert} {\sum }_{( i , j ) ∈ {𝒩}_{( m , n )}} {( {p}_{1} {s}_{( i , j )}^{Y} + {p}_{2} - {v}_{( i , j )}^{Y} )}^{2} + ϵ {p}_{1}^{2} \qquad ( 6 )$$

The above minimization problem has a closed-form solution as shown in equation 7:

$${P}_{( m , n )}^{Y} = \frac{Cov ( {X}_{( m , n )} , {Y}_{( m , n )} )}{Var ( {X}_{( m , n )} ) + ϵ} \qquad ( 7 )$$

$$Here {X}_{( m , n )} = \{ {s}_{( i , j )}^{Y} \vert ( i , j ) ∈ {𝒩}_{( m , n )} \} and {Y}_{( m , n )} = \{ {v}_{( i , j )}^{Y} \vert ( i , j ) ∈ {𝒩}_{( m , n )} \} .$$

Also Cov(X, Y)= [symbol] [(X−X̅)(Y−Y̅)] is variance and Var(X)= [symbol] [X−X̅] is variance, where X̅ and Y̅ are mean of X and Y, respectively.

II.3 Double Channel Linear Model for Chroma

For Cb and Cr channels, both channels can be used to perform the prediction to avoid introducing a color shift from the regression model. The assumption is that if the source pixel is a neutral color, the enhanced pixel should be also the neutral color.

Denote the Cb and Cr channels of source and enhanced images S^{Cb}, S^{Cr}, and V^{Cb}, V^{Cr}, respectively. Shift them so that the neutral color is at 0, i.e., \tilde{S}^{Cb}=S^{Cb}−0.5, and similarly for \tilde{S}^{Cr}, \tilde{V}^{Cb} and \tilde{V}^{Cr}. For pixel (i,j), define the double channel linear model for Cb channel as shown in equation 8:

$${f}_{{p}^{C b}} ( {\tilde{s}}_{( i , j )}^{C b} , {\tilde{s}}_{( i , j )}^{C r} ) = {p}_{1}^{C b} {\tilde{s}}_{( i , j )}^{C b} + {p}_{2}^{C b} {\tilde{s}}_{( i , j )}^{C r} \qquad ( 8 )$$

Therefore, for neutral color, i.e.,

$${\tilde{s}}_{( i , j )}^{C b} = {\tilde{s}}_{( i , j )}^{C r} = 0 , this gives {f}_{{p}^{C b}} ( {\tilde{s}}_{( i , j )}^{C b} , {\tilde{s}}_{( i , j )}^{C r} ) = 0 .$$

Similar to the single channel model, the regularization term can be defined as shown in equation 9:

$$R ( {p}^{C b} ) = ϵ ( {p}_{1}^{C {b}^{2}} + {p}_{2}^{C {b}^{2}} ) \qquad ( 9 )$$

Therefore, for the patch of m-th row and n-th column the minimalization problem is given as shown in equation 10:

$${P}_{( m , n )}^{C b} = arg {min}_{p} \frac{1}{\vert {𝒩}_{( m , n )} \vert} {\sum }_{( i , j ) ∈ {𝒩}_{( m , n )}} {( {p}_{1} {\tilde{s}}_{( i , j )}^{C b} + {p}_{2} {\tilde{s}}_{( i , j )}^{C r} - {\tilde{v}}_{( i , j )}^{C b} )}^{2} + ϵ ( {p}_{1}^{2} + {p}_{2}^{2} ) \qquad ( 10 )$$

Where ϵ is a regularization parameter. In some embodiments, ϵ=(1/2¹⁰)² after normalizing the 10-bit source image to [0,1] scale.

The above minimization problem of equation 10 has the closed-form solution as shown in equation 11:

$${P}_{( m , n )}^{C b} = \frac{C o r r ( {X}_{1} , Y ) [ C o r r ( {X}_{2} ) + ϵ ] - Corr ( {X}_{2} , Y ) Cor r ( {X}_{1} , {X}_{2} )}{{[ C o r r ( {X}_{1} ) + ϵ ] [ Corr ( {X}_{2} ) + ϵ ] - [ Co ] r ( {X}_{1} {X}_{2} ) ]}^{2}} Here {X}_{1} = \{ {\tilde{s}}_{( i , j )}^{C b} \vert ( i , j ) ∈ {𝒩}_{( m , n )} \} , {X}_{2} = \{ {\tilde{s}}_{( i , j )}^{C r} \vert ( i , j ) ∈ {𝒩}_{( m , n )} \} \\ and Y = \{ {\tilde{v}}_{( i , j )}^{C b} \vert ( i , j ) ∈ {𝒩}_{( m , n )} \} . Also Corr ( X ) = 𝔼 [ {X}^{2} ] and Corr ( X , Y ) = 𝔼 [ XY ] \qquad ( 11 )$$

are correlations. The model for Cr channel can be defined in a similar manner.

### III. Acceleration of Enhancement

The patch-wise regression model can also be applied for an acceleration of enhancement. Because the image enhancement can be represented as patch-wise regression model, the model can be fit in a lower resolution and still perform prediction in the original resolution.

III.1 Patch-Wise Regression Model from Downsampled Image

Downsample the source image S with downsampling factor d to get the downsampled source image S′ of resolution W′×H′, where W′=┌W/d┐ and H′=┌H/d┐. The downsampled source image S′ is then sent to the image enhancement process. If the time complexity of the image enhancement process is proportional to the number of pixels, the enhancement time for the downsampled resolution becomes 1/d² of original resolution. For example, when d=4, the enhancement time becomes 1/16=6.25%. For downsampling operation, either use an efficient subsampling strategy by sampling every d pixel in both horizontal and vertical direction or use a more sophisticated downsampling method such as a finite impulse response (FIR) filter.

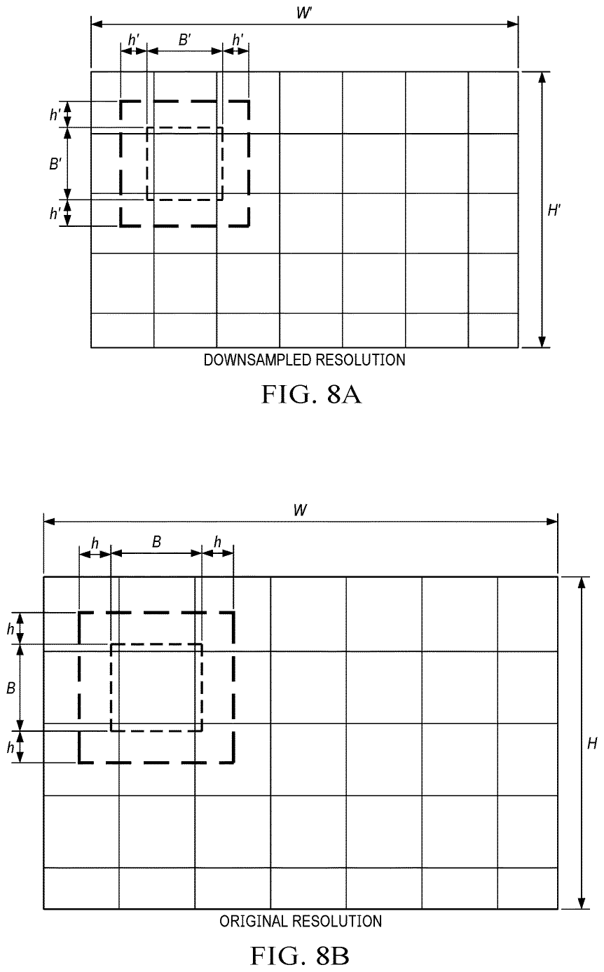

To construct the regression model from the downsampled image, scale the block size and overlap accordingly. If the block size and overlap in original resolution are B and h, the block size and overlap in downsampled resolution become B′=B/d and h′=h/d. For computational efficiency, make the block size and overlap multiples of the downsampling factor d, i.e., mod (B, d)=mod(h, d)=0. Then, construct the patch-wise regression model using the method described in previous sections using the downsampled image resolution W′×H′ and a new block step and overlap B′ and h′. In this case, the patch-wise regression model will have the same size as if calculated from original resolution W×H, block step, overlap B, and h, where H_{P}=┌H′/B′┐=┌H/B┐ and W_{P}=┌W′/B′┐=┌W/B┐. Therefore, it can be used to predict the enhanced image in the original resolution from the original source image as described in Section II. FIGS. 8A and 8B shows a comparison of the patches in downsampled resolution (FIG. 8A) and original resolution (FIG. 8B).

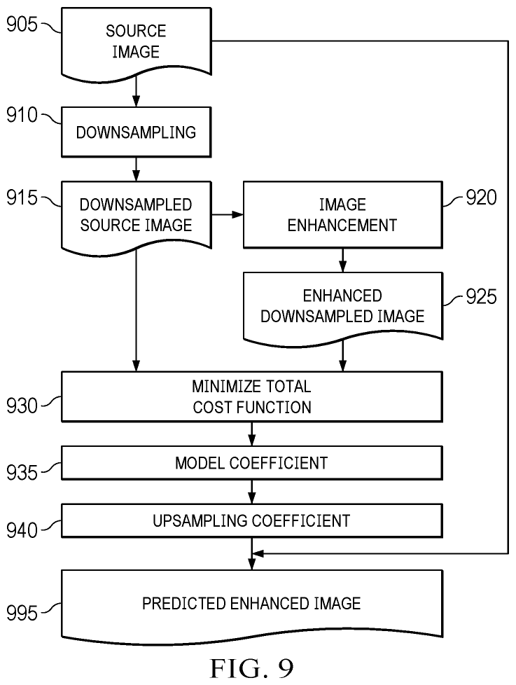

The process of acceleration of enhancement is summarized in the example flowchart of FIG. 9.

The source image (905) is downsampled (910) to produce a downsampled image (915) which is then enhanced (920) to produce an enhanced downsampled image (925). These downsampled images (normal and enhanced) (915, 925) are run through a cost minimization function (930) to extract coefficients (935) for the model. To create a predicted enhanced image (995) from the source image (905), the coefficients (935) are upsampled (940) for the model.

III.2 Quality and Speed Trade-Off

When the image is downsampled, the number of pixels in each patch becomes fewer. This could make the regression model become less stable and introduce artifacts. Also, the quality of enhanced downsampled image may not be as good as enhanced original resolution image.

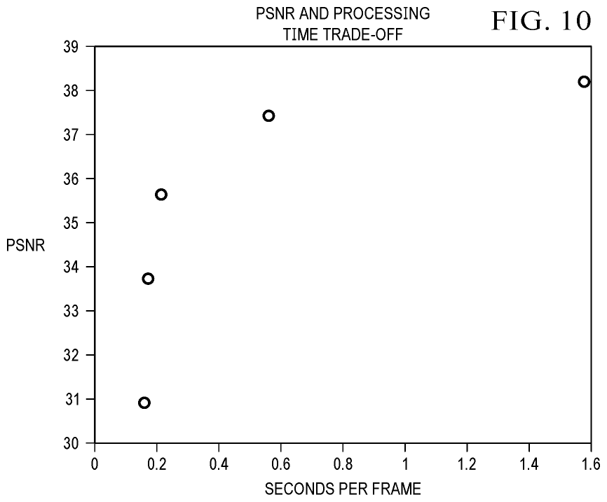

The Table 1 and FIG. 10 show an example of the trade-off between quality and speed over 55 test images. The peak signal-to-noise ratio (PSNR) is measured by taking the enhanced original resolution image as a “ground truth”. When the downsampling factor gets larger, the reduction in processing time diminishes. In some embodiments of the method, a downsampling factor d≤8 is used to maintain a good PSNR.

TABLE 1
PSNR vs Speed

| Downsampling factor d | PSNR (dB) | Speed (sec/frame) |
|---|---|---|
| 1 | 38.301117 | 1.578920 |
| 2 | 37.505819 | 0.560308 |
| 4 | 35.699295 | 0.213991 |
| 8 | 33.764395 | 0.171568 |
| 16 | 30.914444 | 0.158976 |

### IV. Metadata for Enhancement

In some embodiments, the patch-wise regression model can be used to provide metadata for enhancement.

For example, an uploader uploads source image to server for enhancement. Because the image enhancement can be represented as patch-wise regression model, the enhancement and estimate the model can be performed on the server side and sent as the metadata along with the source image to a client. This can avoid re-encoding the enhanced image. On the client side, the enhanced image can be directly predicted from the source image using the model (determined from the metadata) without going through a time-consuming enhancement operation.

IV.1 Quantization and Reconstruction of the Model

IV.1.1 Quantization of the Model

On the server side, first acquire a patch-wise regression model using the methods described in Sections II and III. In some embodiments, the patch-wise regression model is sent as metadata quantized into integers and compressed using entropy coding. Given a patch-wise regression model P and quantization step q, first calculate the initial quantized model as shown in equation 12:

$${Q}_{init}^{C} = round ( {P}^{C} / q ) , C ∈ \{ Y , Cb , Cr \} \qquad ( 12 )$$

However, the initial quantized model might not be optimal in the discrete domain, and the prediction error may be large. Therefore, in some embodiments, iteratively refine the initial quantized model among local neighbors that minimize the total cost defined in Section II, as shown in equation 13.

$${Q}^{C} = refine ( {Q}^{C} , S , V ) , C ∈ \{ Y , Cb , Cr \} \qquad ( 13 )$$

The refined quantized model is in integer form and can be compressed using entropy coding, such as Huffman coding or arithmetic coding. Furthermore, because the adjacent patches might share similar model parameters, in some embodiments the spatial residual of a quantized model of a single image is encoded using differential pulse-code modulation (DPCM) coding (see, e.g., Bruno Aiazzi, Luciano Alparone, and Stefano Baronti “Context modeling for near-lossless image coding.” IEEE Signal Processing Letters 9, no. 3 (2002): 77-80).

In some embodiments, if the input is video, the temporal residual of quantized models can be encoded between adjacent frames to leverage the temporal redundancy. At frame t>1, the residual can be calculated as

$${Q}_{t e m p}^{( t )} = {Q}^{( t )} - {Q}^{( t - 1 )} ∀ t > 1 .$$

Here, Q^{(t)} is the quantized model at frame t. Finally, the encoded model can be treated as metadata and sent along with the bitstream of source image to client side.

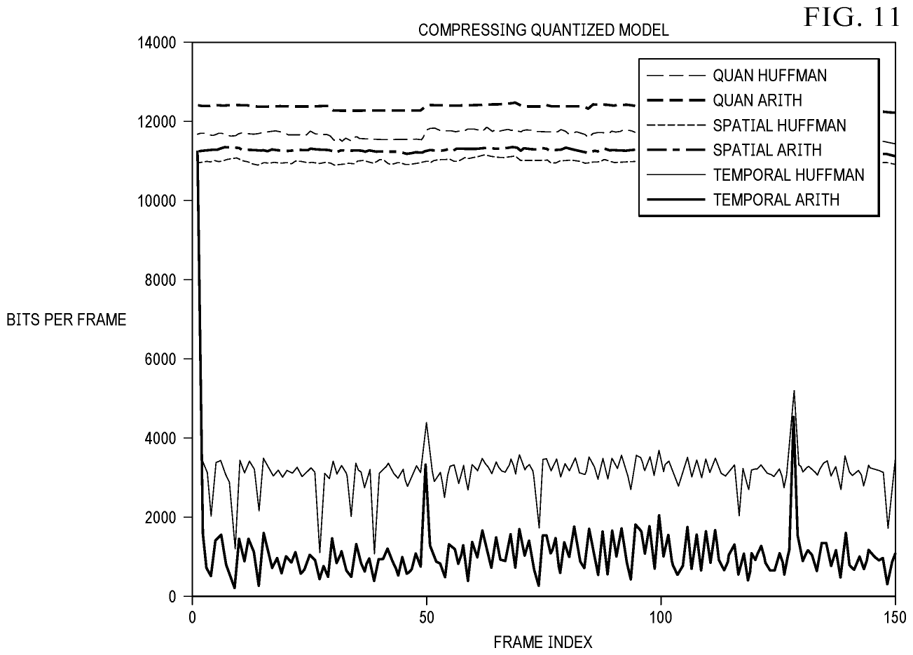

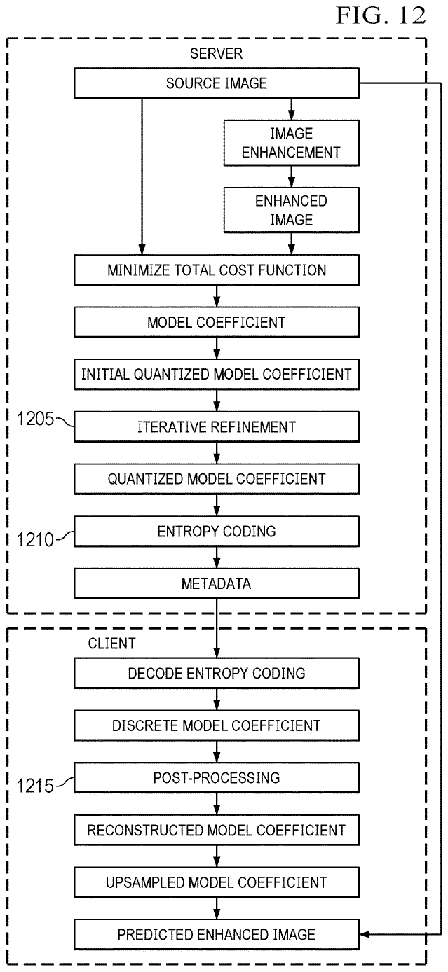

FIG. 11 shows an example of bitrate of various entropy coding methods for 150 frames in a 30-fps video with q=0.05. In this example, the average bitrate using arithmetic coding on the temporal residual is 1.093 kbits/frame or 32.79 kbps.

These examples use spatial and temporal residual encoding, however other encoding models are also applicable as would be understood to one in the art.

In some embodiments, when estimating the regression model on the server side, the acceleration strategy introduced in Section III can be applied to speed-up the process.

IV.1.2 Reconstruction of Model

On the client side, the quantized patch-wise regression model is decoded from the metadata. To predict the enhanced image, convert the quantized model back by applying the quantization step q. This gives the discrete model of each color channel as shown in equation 14.

$${P}_{q}^{C} = q \times {Q}^{C} , C ∈ \{ Y , Cb , Cr \} \qquad ( 14 )$$

However, directly using the discrete model to predict the enhanced image can result in noticeable spatial artifacts. Therefore, in some embodiments, apply post-processing to get the reconstructed model as shown in equation 15:

$${\hat{P}}^{C} = {f}_{gf} ( {P}_{q}^{C} ) , C ∈ \{ Y , Cb , Cr \} \qquad ( 15 )$$

Here f_{gf} is the guided image filter (see e.g., Kaiming He, Jan Sun, and Xiaoou Tang “Guided image filtering.” IEEE transactions on pattern analysis and machine intelligence 35, no. 6 (2012): 1397-1409). The reconstructed model Pc for each color channel can then be used to predict the enhanced image using the methods described in Section II.

An example process of metadata for enhancement is summarized in FIG. 12, including the entropy coding (1210) and iterative refinement (1205) described in Section IV.1.1 above and the post-processing (1215) described for equation 15 above.

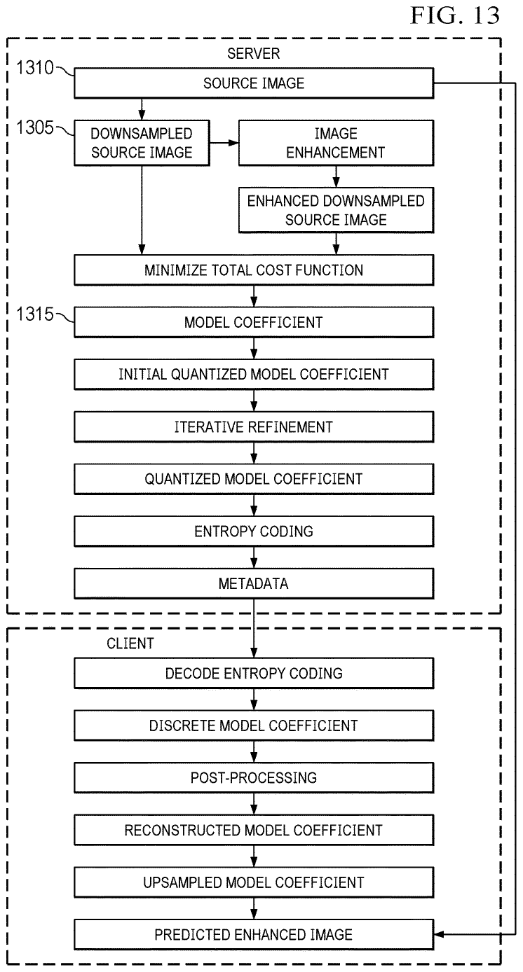

In some embodiments, apply the acceleration method described in Section III on the server side. An example of this process is shown in the FIG. 13 with downsampling (1305) of the source image (1310) prior to determining the coefficients (1315).

### IV.2 Quality and Bitrate Trade-Off

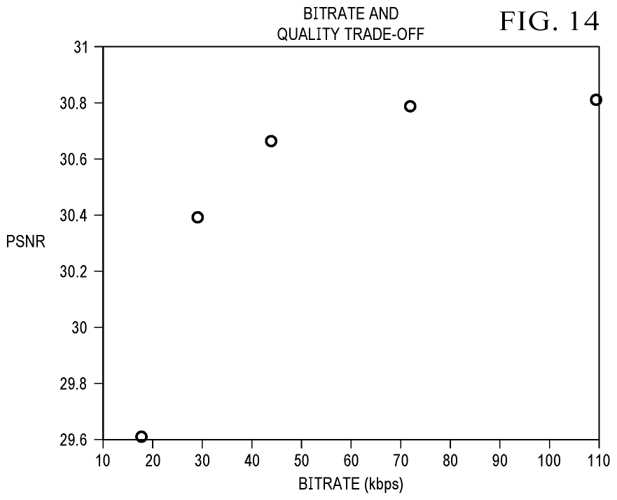

Intuitively, a larger quantization step would lead to smaller bitrate but lower quality. The Table 2 and figure FIG. 14 show the quality and bitrate trade-off. In some embodiments, q≤0.05 to produce acceptable bitrate for the quality.

TABLE 2

| Quantization step q | Bitrate (kbps) | PSNR (dB) |
|---|---|---|
| 0.01 | 109.3140 | 30.814841 |
| 0.02 | 71.8890 | 30.791186 |
| 0.05 | 44.0820 | 30.668807 |
| 0.1 | 29.1000 | 30.392919 |
| 0.2 | 17.8750 | 29.610289 |

### Physical Embodiments

In an embodiment, a computing device such as a display device, a mobile device, a set-top box, a multimedia device, etc., is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Note that, although separate embodiments are discussed herein, any combination of embodiments and/or partial embodiments discussed herein may be combined to form further embodiments.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to the adaptive perceptual quantization of images with enhanced dynamic range, such as those described herein. The computer and/or IC may compute any of a variety of parameters or values that relate to the adaptive perceptual quantization processes described herein. The image and video embodiments may be implemented in hardware, software, firmware and various combinations thereof.

Certain implementations of the inventio comprise computer processors which execute software instructions which cause the processors to perform a method of the disclosure. For example, one or more processors in a display, an encoder, a set top box, a transcoder or the like may implement methods related to adaptive perceptual quantization of HDR images as described above by executing software instructions in a program memory accessible to the processors. Embodiments of the invention may also be provided in the form of a program product. The program product may comprise any non-transitory medium which carries a set of computer-readable signals comprising instructions which, when executed by a data processor, cause the data processor to execute a method of an embodiment of the invention. Program products according to embodiments of the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

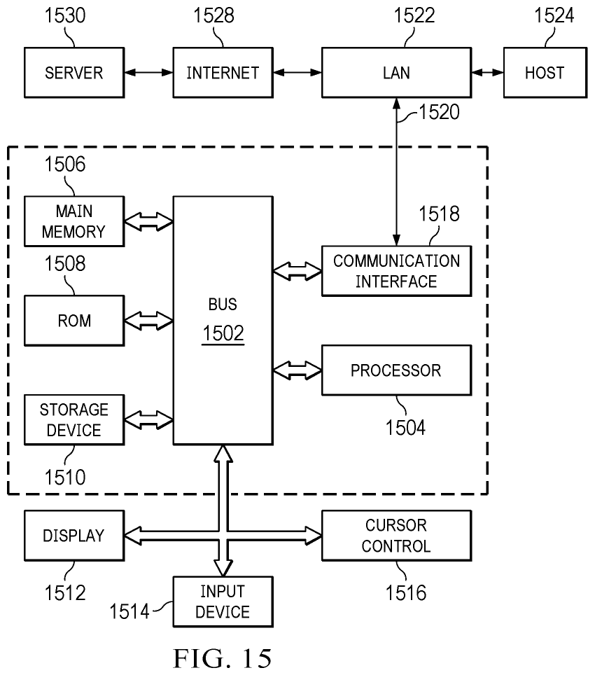

For example, FIG. 15 is a block diagram that illustrates a computer system (1500) upon which an embodiment of the invention may be implemented. Computer system (1500) includes a bus (1502) or other communication mechanism for communicating information, and a hardware processor (1504) coupled with bus (1502) for processing information. A hardware processor (1504) may be, for example, a general-purpose microprocessor.

The computer system (1500) also includes a main memory (1506), such as a random-access memory (RAM) or other dynamic storage device, coupled to bus (1502) for storing information and instructions to be executed by processor (1504). Main memory (1506) also may be used for storing temporary variables or other intermediate information during execution of instructions to be executed by processor (1504). Such instructions, when stored in non-transitory storage media accessible to processor (1504), render computer system (1500) into a special-purpose machine that is customized to perform the operations specified in the instructions.

Computer system (1500) further includes a read only memory (ROM) (1508) or other static storage device coupled to bus (1502) for storing static information and instructions for processor (1504). A storage device (1510), such as a magnetic disk or optical disk, is provided and coupled to bus (1502) for storing information and instructions.

Computer system (1500) may be coupled via bus (1502) to a display (1512), such as a liquid crystal display (LCD) or light emitting diode display (LED), for displaying information to a computer user. An input device (1514), including alphanumeric and other keys, is coupled to bus (1502) for communicating information and command selections to processor (1504). Another type of user input device is cursor control (1516), such as a mouse, a trackball, or cursor direction keys for communicating direction information and command selections to processor (1504) and for controlling cursor movement on display (1512). This input device typically has two degrees of freedom in two axes, a first axis (e.g., x) and a second axis (e.g., y), that allows the device to specify positions in a plane.

Computer system (1500) may implement the techniques described herein using customized hard-wired logic, one or more ASICs or FPGAs, firmware and/or program logic which in combination with the computer system causes or programs computer system (1500) to be a special-purpose machine. According to one embodiment, the techniques as described herein are performed by computer system (1500) in response to processor (1504) executing one or more sequences of one or more instructions contained in main memory (1506). Such instructions may be read into main memory (1506) from another storage medium, such as storage device (1510). Execution of the sequences of instructions contained in main memory (1506) causes processor (1504) to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device (1510). Volatile media includes dynamic memory, such as main memory (1506). Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (1502). Transmission media can also take the form of acoustic or light waves, such as those generated during radio-wave and infra-red data communications.

Various forms of media may be involved in carrying one or more sequences of one or more instructions to processor (1504) for execution. For example, the instructions may initially be carried on a magnetic disk or solid-state drive of a remote computer. The remote computer can load the instructions into its dynamic memory and send the instructions over a telephone line using a modem. A modem local to computer system (1500) can receive the data on the telephone line and use an infra-red transmitter to convert the data to an infra-red signal. An infra-red detector can receive the data carried in the infra-red signal and appropriate circuitry can place the data on bus (1502). Bus (1502) carries the data to main memory (1506), from which processor (1504) retrieves and executes the instructions. The instructions received by main memory (1506) may optionally be stored on storage device (1510) either before or after execution by processor (1504).

Computer system (1500) also includes a communication interface (1518) coupled to bus (1502). Communication interface (1518) provides a two-way data communication coupling to a network link (1520) that is connected to a local network (1522). For example, communication interface (1518) may be an integrated services digital network (ISDN) card, cable modem, satellite modem, or a modem to provide a data communication connection to a corresponding type of telephone line. As another example, communication interface (1518) may be a local area network (LAN) card to provide a data communication connection to a compatible LAN. Wireless links may also be implemented. In any such implementation, communication interface (1518) sends and receives electrical, electromagnetic or optical signals that carry digital data streams representing various types of information.

Network link (1520) typically provides data communication through one or more networks to other data devices. For example, network link (1520) may provide a connection through local network (1522) to a host computer (1524) or to data equipment operated by an Internet Service Provider (ISP). ISP in turn provides data communication services through the worldwide packet data communication network now commonly referred to as the “Internet” (1528). Local network (1522) and Internet (1528) both use electrical, electromagnetic or optical signals that carry digital data streams. The signals through the various networks and the signals on network link 920 and through communication interface (1518), which carry the digital data to and from computer system (1500), are example forms of transmission media.

Computer system (1500) can send messages and receive data, including program code, through the network(s), network link (1520) and communication interface (1518). In the Internet example, a server (1530) might transmit a requested code for an application program through Internet (1528), ISP on the Internet, local network (1522) and communication interface (1518).

The received code may be executed by processor (1504) as it is received, and/or stored in storage device (1510), or other non-volatile storage for later execution.

### HSSL

A construction of a Hybrid Shifted Sigmoid with Linear LUT (HSSL) is explained below. For each color channel, ch (such as Y, R, G, and B) build K (e.g. K=4096) different LUTs, and each LUT is built by merging the shifted sigmoid function and linear function. For each LUT, there are the following parameters:
c^{(ch,k)}: center of sigmoid curve

$${g}_{L}^{( c h , k )} :$$

distance from most left point of sigmoid curve to center of sigmoid curve.

$${g}_{R}^{( ch , k )} :$$

distance from rightest point of sigmoid curve to center of sigmoid curve.

$${m}_{L}^{( c h , / c )} :$$

slope used in the left sigmoid curve

$${m}_{R}^{( c h , k )} :$$

slope used in the left sigmoid curve

The sigmoid function used here is expressed as a function of n.

$$sig ( x , m ) = \frac{1}{1 + exp ( - m ( x - 0.5 ) )} \qquad ( 16 )$$

With a different slope, m, the max and min value will be different. The max and min value can used to normalize the function output to [0 1].

$${sig}_{L , max}^{( ch , k )} = max \{ sig ( x , {m}_{L}^{( ch , k )} ) ∀ x ∈ [ \begin{matrix}0 & 1\end{matrix} ] \}$$

$${sig}_{L , min}^{( ch , k )} = min \{ sig ( x , {m}_{L}^{( ch , k )} ) ∀ x ∈ [ \begin{matrix}0 & 1\end{matrix} ] \}$$

$${sig}_{R , max}^{( ch , k )} = max \{ sig ( x , {m}_{R}^{( ch , k )} ) ∀ x ∈ [ \begin{matrix}0 & 1\end{matrix} ] \}$$

$${sig}_{R , min}^{( ch , k )} = min \{ sig ( x , {m}_{R}^{( ch , k )} ) ∀ x ∈ [ \begin{matrix}0 & 1\end{matrix} ] \}$$

The scaled sigmoid functions for left side and right side are:

$$\text{?} ( x ) = 2 {g}_{L}^{( ch , k )} ( \frac{sig ( \frac{x}{2 {g}_{L}^{( ch , k )}} , {m}_{L}^{( ch , k )} ) - {sig}_{L , min}^{( ch , k )}}{{sig}_{L , max}^{( ch , k )} - {sig}_{L , min}^{( ch , k )}} - 0 \text{.5} ) for x ∈ [ 0 , 2 {g}_{L}^{( ch , k )} ] \qquad ( 17 )$$

$$\text{?} ( x ) = 2 {g}_{R}^{( ch , k )} ( \frac{sig ( \frac{x}{2 {g}_{R}^{( ch , k )}} , {m}_{R}^{( ch , k )} ) - {sig}_{R , min}^{( ch , k )}}{{sig}_{R , max}^{( ch , k )} - {sig}_{R , min}^{( ch , k )}} - 0 \text{.5} ) for x ∈ [ 0 , 2 {g}_{R}^{( ch , k )} ] \qquad ( 18 )$$

The shifted sigmoid functions for left side and right side around c^{(ch,k)} are:

$${LRF}_{L}^{( ch , k )} ( x ) = \text{?} ( x ) + {c}^{( ch , k )} for x ∈ [ 0 , {g}_{L}^{( ch , k )} ]$$

$${LRF}_{R}^{( ch , k )} ( x ) = \text{?} ( x ) + {c}^{( ch , k )} for x ∈ [ {g}_{R}^{( ch , k )} , 2 {g}_{R}^{( ch , k )} ]$$

For the k^{h} reshaping function, LRF^{(ch,k)}(x), set the function to default as 1:1 mapping, (i.e., LRF^{(ch,k)}(x)=x). The following two regions will be replaced by the shifted scaled sigmoid function on the left and right side of

$${c}^{( ch , k )} = \frac{k}{K} .$$

1) For the region

$${ϑ}_{L}^{( ch , k )} = x ∈ [ max ( 0 , {c}^{( ch , k )} - {g}_{L}^{( ch , k )} ) {c}^{( ch , k )} ) , replace {LRF}^{( ch , k )} ( x ) by {LRF}_{L}^{( ch , k )} ( x ) .$$

However, this segment might be shorter than

$${g}_{L}^{( ch , k )} ,$$

so normalize the value again to avoid getting a negative value.

$${LRF}_{L , max}^{( ch , k )} = max \{ {LRF}_{L}^{( ch , k )} ( x ) , ∀ x ∈ {ϑ}_{L}^{( ch , k )} \}$$

$${LRF}_{L , min}^{( ch , k )} = min \{ {LRF}_{L}^{( ch , k )} ( x ) , ∀ x ∈ {ϑ}_{L}^{( ch , k )} \}$$

In some embodiments, the value needs to be scaled if

$${LRF}_{L , min}^{( ch , k )} < 0$$

$$\text{?} ( x ) = {LRF}_{L , max}^{( ch , k )} \frac{{LRF}^{( ch , k )} ( x ) - {LRF}_{L , min}^{( ch , k )}}{{LRF}_{L , max}^{( ch , k )} - {LRF}_{L , min}^{( ch , k )}} \qquad ( 19 )$$

The final replaced value is

$${LRF}^{( ch , k )} ( x ) = \{ \begin{matrix}\text{?} ( x ) & if {LRF}_{L , min}^{( ch , k )} < 0 \\ {LRF}_{L}^{( ch , k )} ( x ) & if {LRF}_{L , min}^{( ch , k )} \geq 0\end{matrix} \qquad ( 20 )$$

The right side can be done similarly.

2) For

$${ϑ}_{R}^{( ch , k )} = x ∈ [ {c}^{( ch , k )} min ( 1 , {c}^{( ch , k )} + {g}_{R}^{( ch , k )} ) ] ,$$

replace LRF^{(ch,k)}(x) by

$${LRF}_{R}^{( ch , k )} ( x ) .$$

However, this segment might be shorter than

$${g}_{R}^{( ch , k )} ,$$

so normalize the value again to avoid getting a value greater than 1.

$${LRF}_{L , max}^{( ch , k )} = max \{ {LRF}_{R}^{( ch , k )} ( x ) , ∀ x ∈ {ϑ}_{R}^{( ch , k )} \}$$

$${LRF}_{L , min}^{( ch , k )} = min \{ {LRF}_{R}^{( ch , k )} ( x ) , ∀ x ∈ {ϑ}_{R}^{( ch , k )} \}$$

In some embodiments, the value is scaled if

$${LRF}_{R , max}^{( ch , k )} > 1$$

$$\text{?} ( x ) = ( 1 - {LRF}_{R , min}^{( ch , k )} ) \frac{{LRF}^{( ch , k )} ( x ) - {LRF}_{R , min}^{( ch , k )}}{{LRF}_{R , max}^{( ch , k )} - {LRF}_{R , min}^{( ch , k )}} + {LRF}_{R , min}^{( ch , k )}$$

The final replaced value is:

$${LRF}^{( ch , k )} ( x ) = \{ \begin{matrix}\text{?} ( x ) & if {LRF}_{R , max}^{( ch , k )} > 1 \\ {LRF}_{R}^{( ch , k )} ( x ) & if {LRF}_{R , max}^{( ch , k )} \leq 1\end{matrix}$$

### EQUIVALENTS, EXTENSIONS, ALTERNATIVES AND MISCELLANEOUS

In the foregoing specification, embodiments of the invention have been described with reference to numerous specific details that may vary from implementation to implementation. Thus, the sole and exclusive indicator of what is claimed embodiments of the invention and is intended by the applicants to be claimed embodiments of the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

### Enumerated Exemplary Embodiments

The invention may be embodied in any of the forms described herein, including, but not limited to the following Enumerated Example Embodiments (EEEs) which describe structure, features, and functionality of some portions of embodiments of the present invention.

EEE1: A method for image enhancement of a source image, the method comprising: downsampling the source image to produce a downsampled image; enhancing the downsampled image to produce an enhanced downsampled image; dividing the enhanced downsampled image into blocks; determining patches over each of the blocks such that each patch overlaps at least one surrounding block; and creating a predicted enhanced image using a patch-wise regression model based on said patches on the source image.

EEE2: The method of EEE1, wherein the method is performed at an image uploader and the predicted enhanced image is sent to a server or a client system.

EEE3: The method of EEE1, wherein the method is performed at an image server and the source image is obtained from an image uploader system and the predicted enhanced image is sent to a client system.

EEE4: The method of EEE1, wherein the method is performed at a client system and the source image is obtained from an image uploader system or an image server system and the predicted enhanced image is stored by the client system and/or displayed by the client system.

EEE5: The method of any of EEEs 1-4, wherein the creating a predicted enhanced image further comprises: using the downsampled image and the enhanced downsampled image to generate the patch-wise regression model; spatially and bi-linearly interpolate the patch-based regression model to a pixel-based model; and using the pixel-based model in the creating the predicted enhanced image.

EEE6: The method of any of EEEs 1-5, further comprising minimizing a cost function to determine coefficients for the patch-wise regression model.

EEE7: The method of EEE6, further comprising quantizing the coefficients.

EEE8: The method of any of EEEs 1-7, wherein the patch-wise regression model is a single channel model.

EEE9: The method of any of EEEs 1-7, wherein the patch-wise regression model is a multichannel model.

EEE10: The method of any of EEEs 1-7, wherein the patch-wise regression model includes a regularization term.

EEE11: The method of any of EEEs 1-10, further comprising iterative refinement of the patch-wise regression model.

EEE12: The method of any of claims 1-11, further comprising entropy coding the patch-wise regression model.

EEE13: The method of claim 12, wherein the entropy coding comprises differential pulse-code modulation.

EEE14: A method for image enhancement of a source image, the method comprising: enhancing the source image; using a patch-wise regression model to determine coefficients configured to predict an enhanced image; sending the coefficients as metadata to a client for predicting an enhanced image.

EEE15: The method of EEE14, further comprising downsampling the source image before the enhancing.

EEE16: The method of any of EEEs 14-15, further comprising quantizing the coefficients.

EEE17: The method of any of EEEs 14-15, further comprising iterative refinement of the patch-wise regression model.

EEE18: The method of any of EEEs 14-17, further comprising entropy coding the patch-wise regression model.

EEE19: The method of EEE18, wherein the entropy coding comprises differential pulse-code modulation.

EEE20: A method of image enhancement of a source image, the method comprising: receiving the source image and metadata related to the source image; extracting patch-wise regression coefficients from the metadata; spatially upsampling the patch-wise regression coefficients to produce spatially upsampled coefficients; creating a predicted enhanced image by using a patch-wise regression model with the spatially upsampled coefficients on the source image.

EEE21: The method of EEE20, further comprising post-processing the patch-wise regression coefficients prior to the spatially upsampling.

EEE22: The method of any of EEEs 20-21, further comprising entropy decoding the metadata.

EEE23: An apparatus comprising a processor and configured to perform one of the methods recited in EEEs 1-22.

EEE24: The apparatus of EEE23, wherein the apparatus is the same device as a device displaying the image.

EEE25: The apparatus of EEE24, wherein software for performing the image is a stand-alone software package separate from, but interacting with, software used to display the image.

EEE26: An apparatus comprising a processor and configured to perform one of the methods recited in EEEs 1-13 or 20-22, wherein the apparatus comprises a video decoder and the method is performed in the video decoder.

EEE27: A non-transitory computer-readable storage medium having stored thereon computer-executable instruction for executing a method with one or more processors in accordance with any of the methods recited in EEEs 1-22.

1-27. (canceled)

28. A method for contrast, brightness and/or saturation enhancement of a source image, the method comprising:
downsampling the source image of an original resolution to produce a downsampled image;
enhancing the downsampled image to produce an enhanced downsampled image;
dividing the enhanced downsampled image into blocks;
determining patches over each of the blocks such that each patch overlaps at least one surrounding block;
generating a patch-wise regression model using the downsampled image and the enhanced downsampled image, wherein each patch has its own regression model representing a patch enhancement; and
creating a predicted enhanced image from the source image using the patch-wise regression model, wherein the patch-wise regression model generates the predicted enhanced image in the original resolution.

29. The method of claim 28, wherein the method is performed at an image uploader and the predicted enhanced image is sent to a server or a client system.

30. The method of claim 28, wherein the method is performed at an image server and the source image is obtained from an image uploader system and the predicted enhanced image is sent to a client system.

31. The method of claim 28, wherein the method is performed at a client system and the source image is obtained from an image uploader system or an image server system and the predicted enhanced image is stored by the client system and/or displayed by the client system.

32. The method of claim 28, wherein the creating the predicted enhanced image further comprises:
spatially and bi-linearly interpolating the patch-wise regression model to a pixel-based model; and
using the pixel-based model in the creating the predicted enhanced image.

33. The method of claim 28, further comprising minimizing a cost function to determine coefficients for the patch-wise regression model and quantizing the coefficients.

34. The method of claim 28, wherein the patch-wise regression model is a single channel model or a multichannel model.

35. The method of claim 28, wherein the patch-wise regression model includes a regularization term.

36. The method of claim 28, further comprising iterative refinement of the patch-wise regression model.

37. The method of claim 28, further comprising entropy coding the patch-wise regression model.

38. The method of claim 37, wherein the entropy coding comprises differential pulse-code modulation.

39. A method for image enhancement of a source image, the method comprising:
enhancing the source image;
using a patch-wise regression model to determine coefficients configured to predict an enhanced image; and
sending the coefficients as metadata to a client for predicting the enhanced image.

40. The method of claim 39, further comprising downsampling the source image before the enhancing.

41. The method of claim 39, further comprising iterative refinement of the patch-wise regression model.

42. The method of claim 39, further comprising entropy coding the patch-wise regression model.

43. The method of claim 42, wherein the entropy coding comprises differential pulse-code modulation.

44. A method of image enhancement of a source image, the method comprising:
receiving the source image and metadata related to the source image;
extracting patch-wise regression coefficients from the metadata;
spatially upsampling the patch-wise regression coefficients to produce spatially upsampled coefficients; and
creating a predicted enhanced image by using a patch-wise regression model with the spatially upsampled coefficients on the source image.

45. The method of claim 44, further comprising post-processing the patch-wise regression coefficients prior to the spatially upsampling.

46. An apparatus comprising a processor and configured to perform the method recited in claim 28.

47. A non-transitory computer-readable storage medium having stored thereon computer-executable instruction for executing a method with one or more processors in accordance with the method recited in claim 28.
